(19) United States
(12) Patent Application Publication
(10) Pub. No.: US 2004/0207895 A1
(43) Pub. Date: Oct. 21, 2004

(54) Calibration method to maximize field of view in an optical wireless link

(76) Inventors: Eric G. Oettinger, Rochester, MN (US); Mark D. Heminger, Rochester, MN (US)

Correspondence Address: TEXAS INSTRUMENTS INCORPORATED, P O BOX 655474, M/S 3999, DALLAS, TX, 75265

(21) Appl. No.: 10/152,224

(22) Filed: May 20, 2002

(51) Int. Cl. H04B 10/00

(52) U.S. Cl. 359/212

(57) ABSTRACT

A method 400 of maximizing the field of view associated with an OWL by providing a value for an offset and a maximum radius to use during an acquisition scan to prevent collisions in a micro-electro-mechanical (MEM) mirror assembly associated with the OWL. The field of view is maximized by measuring the range of travel in the positive and negative directions along each axis, and using the midpoints to define a new origin to use as the center or the spiral scan. This new center will typically be offset from the original center as defined by the zero current location.

### BACKGROUND OF THE INVENTION

1. Field of the Invention

This invention relates generally to an optical wireless link, and more particularly, to a method of calibrating an optical wireless link to maximize its field of view.

2. Description of the Prior Art

A very convenient scan pattern to use in acquisition is a spiral with a radius which expands slowly enough such that in combination with the divergence associated with the transmitting laser will ensure that there will be some overlap from pass to pass. During the coarse acquisition process, signals are monitored to determine if any new feedback information is received. This feedback information may be monitored, for example, using an “ICUC” (“I see, you see”) acquisition spiral that spirals in and out, transmitting both its local position as it goes, along with the most recent value of the remote that it has seen. The spiral is therefore transmitting what “I see” and the remote is transmitting what “you see”.

One aspect of micro electromechanical (MEM) mirrors is that the transient response of the mirror due to mirror collisions can last for up to several seconds. Mirror collisions comprise contact between any parts of the mirror as it is moved. The “parts” may include either an edge of the mirror itself, one of the motor magnets or coils used to move the mirror, the substrate upon which the mirror is mounted, or the parts of the internal mirror stops which prevent the mirror from rotating too far. As the mirror is rotated, the first parts that will come in contact depend on the angle in which the mirror is moved, as well as variability in the manufacturing process which may affect physical location of the parts.

Because of the long response times, mirror collisions are problematic during acquisition scanning because they cause the mirror to behave unpredictably and effectively halt the scan until the transients die down. Collisions therefore must be avoided during the scan. Avoidance is accomplished via limiting the maximum radius used in the scan. Because the maximum radius also sets the field of view of the transmitter, limiting the maximum radius, has the undesirable effect of also limiting the field of view.

In view of the foregoing, it would be both desirable and advantageous in the optical wireless communication art to provide a technique that maximizes the field of view associated with an OWL while providing a value for a maximum radius to use during an acquisition scan to prevent collisions associated with a micro-electro-mechanical (MEM) mirror assembly from occurring.

### SUMMARY OF THE INVENTION

The present invention is directed to a technique that maximizes the field of view associated with an OWL while providing a value for a maximum radius to use during an acquisition scan to prevent collisions associated with a micro-electro-mechanical (MEM) mirror assembly associated with the OWL from occurring. The radius in a two-axis mirror is typically limited by a feature encountered along one of the two primary axes. The field of view is then maximized by measuring the range of travel in the positive and negative directions along each axis, and using the midpoints to define a new origin to use as the center or the spiral scan. This new center will typically be offset from the original center as defined by the zero current location.

A value for the maximum radius to use during an acquisition scan is implemented via an algorithmic software to apply a gain to either the measured position, or the control effort output based on the range of travel, allowing the algorithmic software to use the same value for the maximum radius for all mass produced MEM mirrors. An alternative implementation varies the maximum radius on a per mirror basis.

In one aspect of the invention, a technique that maximizes the field of view associated with an OWL is implemented to avoid the necessity of making assumptions regarding the maximum radius and offset for all mirrors to avoid hitting the stops.

In another aspect of the invention, a technique maximizes the field of view associated with an OWL to eliminate some margin for variability generally associated with MEM mirrors.

According to one embodiment, a method of maximizing a field of view associated with an optical wireless link comprises measuring the range of mirror travel occurring in both positive and negative directions along predetermined axes to determine resultant midpoints that define a new origin to use as the center of an acquisition spiral. Using this new origin as the center of the acquisition spiral, and using a desired maximum radius measured from the new origin, the field of view associated with the mirror is maximized in a manner that avoids mirror collisions.

According to yet another embodiment, an optical wireless link (OWL) calibration system comprises an OWL having a laser beam transmitter, a micro-electro-mechanical (MEM) mirror operational to reflect a light beam generated by the laser beam transmitter, an optical detector operational to monitor feedback information generated by a remote OWL, and a controller operational to control movement of the MEM mirror in response to the feedback information; and an algorithmic software, wherein the controller, directed by the algorithmic software, operates to maximize a field of view associated with the MEM mirror.

### BRIEF DESCRIPTION OF THE DRAWINGS

Other aspects, features and advantages of the present invention will be readily appreciated, as the invention becomes better understood by reference to the following detailed description when considered in connection with the accompanying drawing figures wherein:

FIG. 1 is a block diagram illustrating a pair of OWLs communicating with one another in which each OWL includes a transmitter, receiver and a processor/controller;

FIG. 2 is a system block diagram illustrating optical components within an OWL;

FIG. 3 is a system block diagram illustrating a micro-electro-mechanical (MEM) mirror control system; and

FIG. 4 is a block diagram depicting a method of calibrating an optical wireless link to maximize its field of view according to one embodiment of the present invention.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

FIG. 1 is a block diagram illustrating an OWL system 100 having a pair of OWLs 102, 104 communicating with one another in which OWLs 102, 104 include respective transmitters 106, 114, receivers 108, 116 and processors 110, 118. Each transmitter 106, 114 is able to change the direction of its transmitted beam by known amounts of angular displacement. The receivers 108, 116 see this motion as a linear displacement, and send position correction information back to the remote station via its respective transmitter 106, 114. This feedback is used by a servo control loop algorithm to position the transmitted beam on the respective receiver 108, 116 of the remote station.

Generally, there is a sensor in each unit of an optical wireless link (OWL) used to measure the direction of the transmitted beam relative to the station in which the transmitter is mounted. This sensor can also be used to detect the range of travel of the mirror.

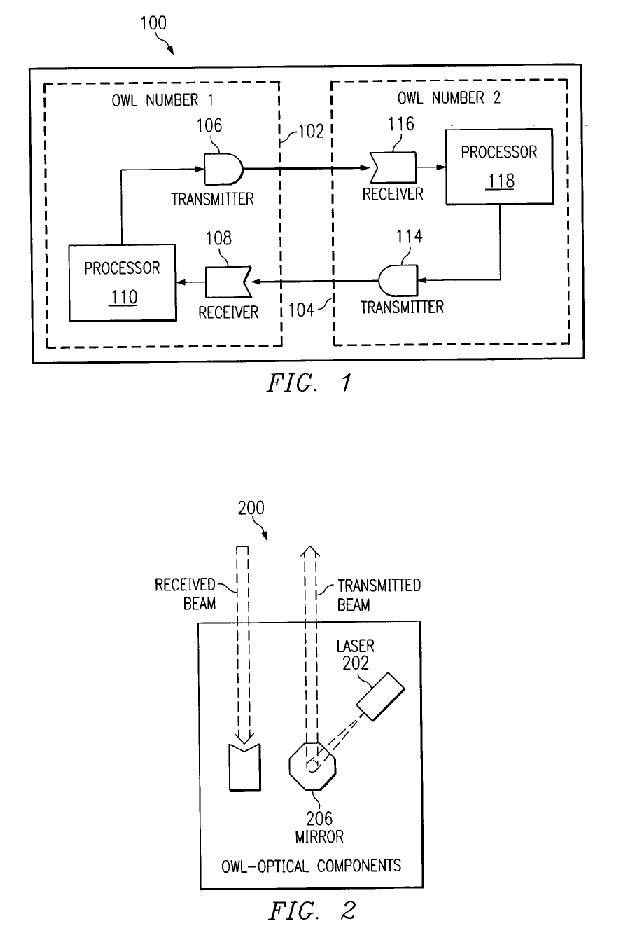

FIG. 2 is a system level diagram illustrating typical optical components within an OWL 200. In addition to the standard components discussed herein before with reference to FIG. 1, OWL 200 can be seen to also include a laser beam generator 202 and a micro-electro-mechanical (MEM) mirror 206. For purposes of brevity and to improve clarity, the particular embodiments discussed herein are described in terms of a MEM mirror having two axes associated with its movement. The present invention is not so limited however, the principles discussed herein below can easily be extrapolated to mirrors having more than two axis associated with mirror movements. Assuming then that MEM mirror 206 has two axis associated with its movements, it can be appreciated that the field of view is then substantially square. The present inventors recognized the field of view associated with MEM mirror 206 can be maximized by measuring the range of travel in the positive and negative directions along each axis, and then using the midpoints to define a new origin as the center of the spiral scan discussed herein before. This new center will typically be offset from the center as defined by the zero current location.

The present inventors also recognized that setting a value for a maximum radius to use during the acquisition scan would prevent collisions of the MEM mirror 206. According to one embodiment, setting a value for a maximum radius to use during the acquisition scan is implemented via an algorithmic software that applies a gain to the measured MEM mirror 206 position based on the range of travel, such that the algorithmic software code can use the same value for the maximum radius, regardless of the actual physical MEM mirror that is used in the OWL.

It can be appreciated that when the foregoing calibration is not performed, then assumptions must be made regarding the maximum radius and offset for any mirror that is used by the OWL in order to avoid collisions. These defaults must include some margin for variability, and will unnecessarily limit the field of view.

Limiting the value for the maximum radius however, means that the field of view will also be limited. This means that two OWL units must be aligned fairly well to start. It can therefore be appreciated that less precision required here will mean less work to set up the system. Most preferably then, the value for the maximum radius will be as large as possible. The radius then must be maximized while still preventing collisions from occurring. This is done by centering the spiral in the range of motion as now described.

FIG. 3 is a system block diagram 300 illustrating a micro-electro-mechanical (MEM) mirror control system 300. MEM control system 300 can be seen to have a MEM mirror assembly 302 including an internal (local) sensor 304, as well as a controller 306 that function generally as described in U.S. patent application, entitled Method Of Sampling Local And Remote Feedback In An Optical Wireless Link, docket number TI-33553, filed on May ______, 2002, by Oettinger et al., assigned to Texas Instruments Incorporated, the assignee of the present application, and that is hereby incorporated by reference in its entirety herein.

The present inventors found that it is possible (actually typical), that movement of the MEM mirror 302 along an axis will be greater in one direction than the other. If, for example, a value of zero is applied to the DAC shown in FIG. 3, a valid center position of the mirror is assumed to occur. If the value applied to the DAC is slowly increased such that movement occurs along the positive x-axis until a collision occurs, then the sensed position (from the local feedback sensor also shown in FIG. 3) will gradually increase and then stop increasing when the mirror 302 cannot move any further. A DAC input value of 1,000 units may for example, cause the mirror 302 to move 80 mrad. Gradual movement of mirror 302 in the opposite direction (along the negative x-axis) however, may stop when the mirror 302 has moved −100 mrad, and when a value of 1,250 has been written to the DAC. If the center is not adjusted, the maximum radius is then limited to 80 mrad. Adjusting the center between +80 mrad and −100 mrad, will however, desirably increase the maximum radius from 80 mrad to 90 mrad.

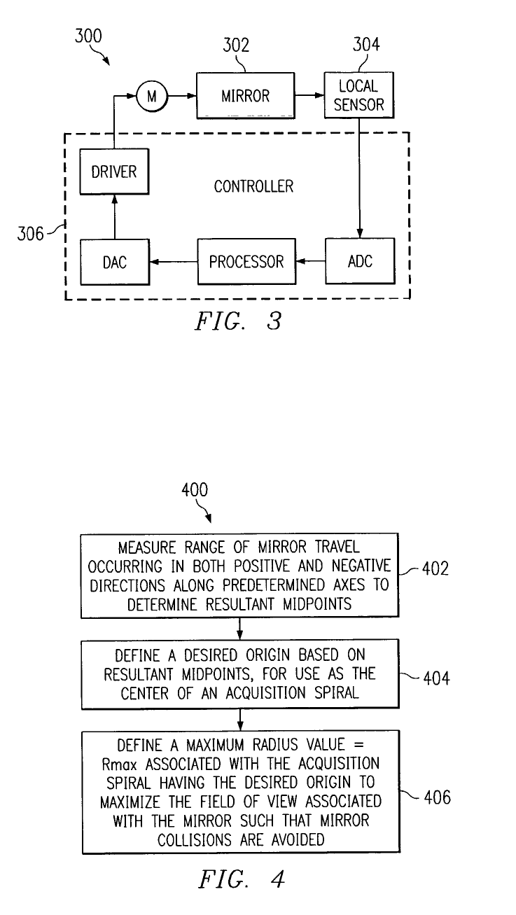

FIG. 4 is a block diagram depicting a method 400 of calibrating an optical wireless link to maximize its field of view according to one embodiment of the present invention. The method 400 begins by first measuring the maximum range of mirror travel occurring in both positive and negative directions along the x-axis and along the y-axis and then determining the resultant midpoints as shown in block 402. Next, as shown in block 404, a new origin (center) is defined using the resultant midpoints. This new center will typically be offset from the center as defined by the zero current location as stated herein before. Finally, as shown in block 406, a maximum radius value=Rmax is defined with reference to the new origin such that an acquisition spiral having its origin located at the new center can be used to implement a scan in a manner that maximizes the field of view associated with the mirror while avoiding mirror collisions.

A value for a maximum radius to use during an acquisition scan to perform each seek is implemented in a manner, for example, that prevents MEM mirror 206 from hitting the stops. More specifically, a desired gain is applied to the measured position based on the range of travel, allowing the same value to be used for the maximum radius for all MEM mirrors that may be integrated into the OWL. In summary explanation, the control level output can be scaled as desired rather than generating different maximum radii for each individual MEM mirror 206. The maximum radius may, for example, be hard coded to be 100 mrad. Using the system parameters discussed herein above, the sensor output would then be multiplied by 90/100 before sending the output to the DAC. This would have the effect of making the maximum spiral radius implemented in code always go to 100, which would also be the effective maximum radius (90 mrad).

If a circular scan pattern is implemented, setting the maximum radius equal to the minimum found for each axis will prevent collisions from occurring on any axis. It is noted that, because the output for both axes can be scaled individually, in one embodiment, the resulting scan pattern could be an oval rather than a circle by maintaining a distinct gain for each axis.

In view of the above, it can be seen the present invention presents a significant advancement in the art of optical wireless communication techniques. Further, this invention has been described in considerable detail in order to provide those skilled in the MEM mirror art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims that follow.

What is claimed is:

1. A method of maximizing a field of view associated with an optical wireless link, the method comprising the steps of:
measuring a range of mirror travel occurring in both positive and negative directions along predetermined mirror axes;
determining resultant midpoints associated with the measured range of mirror travel along each predetermined mirror axes; and
defining an origin based on the resultant midpoints.

2. The method according to claim 1 wherein the predetermined axes comprise an x-axis and a y-axis associated with a micro-electro-mechanical mirror.

3. The method according to claim 1 wherein the defined origin is offset from an origin defined by a zero current location.

4. The method according to claim 1 further comprising the step of defining a maximum radius value relative to the defined origin, such that an acquisition spiral scan can be implemented in a manner that maximizes the field of view associated with the mirror, and further in a manner that prevents mirror collisions.

5. An optical wireless link (OWL) calibration system comprising:
an OWL having a laser beam transmitter, a micro-electro-mechanical (MEM) mirror operational to reflect a light beam generated by the laser beam transmitter, an optical detector operational to monitor feedback information generated by a remote OWL, and a controller operational to control movement of the MEM mirror in response to the feedback information; and
an algorithmic software, wherein the controller, directed by the algorithmic software, operates to maximize a field of view associated with the MEM mirror.

6. The OWL calibration system according to claim 5 wherein the controller, directed by the algorithmic software, further operates to prevent physical collisions associated with the MEM mirror.

7. The OWL calibration system according to claim 5 wherein the controller, directed by the algorithmic software, further operates to control a maximum radius that is used by the MEM mirror during an acquisition spiral scan.

8. The OWL calibration system according to claim 5 wherein the controller, directed by the algorithmic software, further operates to apply a desired gain to a MEM mirror position based on a range of travel such that a single maximum radius value associated with MEM mirror position accommodates a desired margin of variability associated with a plurality of similar but different MEM mirrors.
